(19) United States
(12) Patent Application Publication
(10) Pub. No.: US 2012/0109731 A1
(43) Pub. Date: May 3, 2012

(54) METHOD OF PROMOTION BASED ON PRODUCTS CONSUMPTION

(76) Inventor: Rod N. Averbuch, Chicago, IL (US)

(21) Appl. No.: 13/344,483

(22) Filed: Jan. 5, 2012

Related U.S. Application Data
(63) Continuation-in-part of application No. 12/643,311, filed on Dec. 21, 2009.
(60) Provisional application No. 61/442,539, filed on Feb. 14, 2011.

(51) Int. Cl. G06Q 30/02

(52) U.S. Cl. 705/14.24; 705/14.4

(57) ABSTRACT

A Product Storage facility calculates each product's consumption pattern by sensing the presence and absence of an RFID signal from each package or by other means. Sensing of an optical Bar-code content could also be used to determine the consumption patterns of the products. The Product Storage broadcasts consumption patterns to Display Devices (DDs). A Display Device (DD) application utilizes the product ID information to search for lot-based or non-lot-based promotion of products. The personalized presented promotions on the (DD) display are at least for lots of products that their remaining shelf life matches the family's typical consumption pattern.

### RELATED APPLICATIONS

This application claims the benefit of priority of U.S. Provisional Patent Application No. 61/442,539, filed on Feb. 14, 2011, and titled A METHOD OF PROMOTION BASED ON PRODUCTS CONSUMPTION by the same inventor (Averbuch).

This application is also a continuation-in-part of a pending U.S. patent application Ser. No. 12/643,311 filed on Dec. 21, 2009 and titled A METHOD OF PRODUCT PRICE PROMOTION by the same inventor (Averbuch).

### BACKGROUND OF THE INVENTION

The average food retailer earns about 1% in net profit, but only after losing more than 2% to products' waste. Most of the waste is from perishables reaching the end of their shelf-life. Wasted food negatively impacts manufacturers, retailers, consumers and the environment. The energy and material invested in growing, producing, transporting, storing and displaying a product are wasted when products end up in a landfill. Fresh-Food typically has a short shelf-life therefore, could expire quickly. Other non-food products such as drugs could also be considered as perishable and could benefit from this invention. Lot-based product promotion, which is related to product's remaining shelf-life is an effective means to proactively reduce wasted products and energy by shaping consumer demand for specific lots. This concept also improves food and drug safety as products from specific lots could be safely sold and used based on anticipated consumption-pattern. Other advantages such as maintaining the proper home inventory level for fresh-food and drugs are presented by another embodiments of this invention. This invention is a continuation-in-part of U.S. patent application Ser. No. 12/643,311 a method of product price promotion filed by the same inventor (Averbuch). U.S. patent application Ser. No. 12/643,311 teaches product type members promotion from specific lots based on product member's remaining shelf-life, inventory level and other promotional considerations. U.S. patent application Ser. No. 12/643,311 also discloses a personalized promotion application, which is based on purchasing pattern of specific product by the consumer. U.S. patent application Ser. No. 12/643,311 does not disclose an adaptive calculation of product consumption-pattern by a Product Storage Controller that is later used to identify and present lot-based and other promotion information.

U.S.20090282859 System for Remotely Controlling and Monitoring a Food Refrigerator and its Content (Glielmo; Luigi; et al) is an application in field of food monitoring inside a refrigerator by utilizing RFID devices information. Two embodiments are disclosed in this application. The first embodiment teaches a remote inventory monitoring of refrigerator's content utilizing GSM/GPRS cellular network. The second embodiment teaches the remote monitoring by a control unit that checks and stores a plurality of functioning parameters of the food refrigerator utilizing RFID stored data. This application does not disclose an adaptive calculation of product consumption-pattern by a Product Storage Controller that is used to identify and present lot-based and other promotion information.

U.S.20080274757 System and Method for Enhanced Item Tracking (Lovell) is another application in field of food monitoring inside a refrigerator utilizing RFID devices. Two main embodiments are disclosed in this application. The first embodiment teaches remotely tracking of products utilizing an RFID information that is transmitted to Wireless Device indicating a change in the presence, status, condition, etc. of an item.

The second embodiment teaches a definition of information by Mobile Subscriber that includes at least one of Identifying Information, Device Information, Item Information, Alert Information, and Billing Information. The information may further be preserved through a User Profile. This application does not disclose an adaptive calculation of product consumption-pattern by a Product Storage Controller that is used to identify and present lot-based and other related promotion information.

U.S.20080250797 REFRIGERATOR INCLUDING FOOD PRODUCT MANAGEMENT SYSTEM (ROZENDAAL)

This application teaches an RFID reading capable Refrigerator that reads the RFID information from the product packages in the Refrigerator. The refrigerator in this invention can determined product's expiration based on the elapsed time and the expiration information on the RFID. The refrigerator alerts the consumer about expiration conditions directly or indirectly via email. In another embodiment the refrigerator gets from the Internet other information regarding the product.

This application does not disclose an adaptive calculation of product consumption-pattern by a Product Storage Controller that is used to identify and present lot-based and other promotion information.

U.S.20070016852 Refrigerator for managing food by using RFID (Kim) teaches a refrigerator system that manages the food inside the refrigerator by utilizing RFID information. The refrigerator in this invention utilizes parameter information from RFIDs to properly store products in different refrigerator's storage sections. The controller determines the conditions in every section of the refrigerator by reading sensors that are placed in every refrigerator's section. This application does not disclose an adaptive calculation of product consumption-pattern by a Product Storage Controller that is used to identify and present lot-based and other promotion information.

U.S.20040100380 RFID system and method for tracking food freshness (Lindsay) teaches a freshness tracking system that detects expiration time and alert the user. The system utilizes information from smart tag (RFID) such as production date and expiration date. This invention also claims management of food in the refrigerator based on freshness level.

This application does not disclose an adaptive calculation of product consumption-pattern by a Product Storage Controller that is used to identify and present lot-based and other promotion information.

### SUMMARY OF THE INVENTION

A Product Storage (PS) is a new Product Storage facility that contains stored products and controller sections. Examples for such Product Storage are, but not limited to: refrigerator, kitchen cabinets and medicine cabinets. The (PS) Controller (PSC) 110 automatically and continually calculates each product's adaptive consumption-pattern by sensing the presence and absence intervals of an RFID signal from each package.

Sensing of optical Bar-code could be also used to determine the consumption-patterns of the products. The Product Storage Controller (PSC) 110 broadcasts the consumption-patterns of the products to Display Devices (DD) 160. In some embodiments a Display Device (DD) 160 application utilizes the consumption-pattern information to search for lot-based or other type of product promotions. The personalized presented promotions by the (DD) 160 are for products that their remaining shelf-life matches the family's typical consumption-pattern previously broadcasted by the Product Storage Controller (PSC) 110. The lot-based promoted products in one embodiment utilizing Cycled Discount Labeling techniques described and illustrated in U.S. patent application Ser. No. 12/643,311 a method of product price promotion. U.S. patent application Ser. No. 12/643,311 was previously filed by the same inventor of this invention (Averbuch). In other embodiments the product promotions, which displayed by (DD) 160 are not related to a specific lot yet it is offered to the consumer based on its product's consumption-pattern and product's inventory level at home.

### BRIEF DESCRIPTION OF THE FIGURES

FIG. 1 is a system block diagram illustrating the system elements and interfaces between the elements in the home environment in accordance with some embodiments.

FIG. 2 is a system block diagram illustrates the system elements and interfaces between the elements in street, supermarket, and office environment in accordance with some embodiments.

FIG. 3 is a flow chart logic that is executed by the Processor (P) 125 inside the Product Storage Controller (PSC) 110 in accordance with some embodiments.

FIG. 4 is a flow chart logic that is executed by the Display Device (DD) 160 in accordance with some embodiments

FIG. 5 Illustrates one allocation of Cycled Discount Labels (CDL) example as disclosed in U.S. patent application Ser. No. 12/643,311 a method of product price promotion. The complete (CDL) allocation and promotion presentation techniques that are claimed in U.S. patent application Ser. No. 12/643,311 could be utilized by this invention.

FIG. 6A is a flow chart illustrating consumption-pattern profile update example of internal or external servers by the (DD) 160 or by the (P) 125 inside the Product Storage Controller (PSC) 110 in accordance with some embodiments.

FIG. 6B is a flow chart of promotions download example by the internal servers or the external servers (237, 239) in accordance with some embodiments.

### DETAILED DESCRIPTION

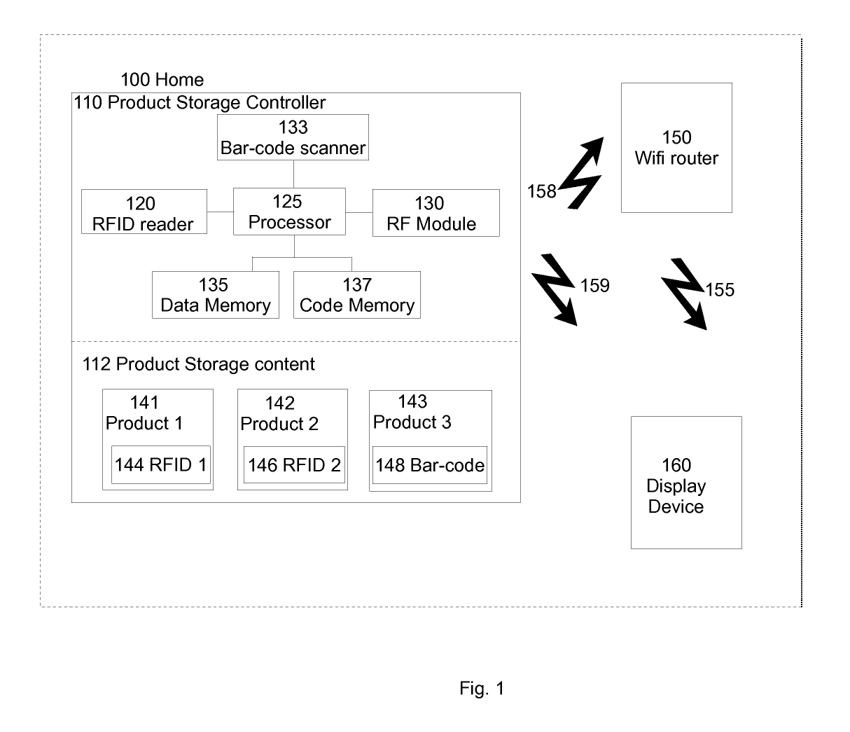

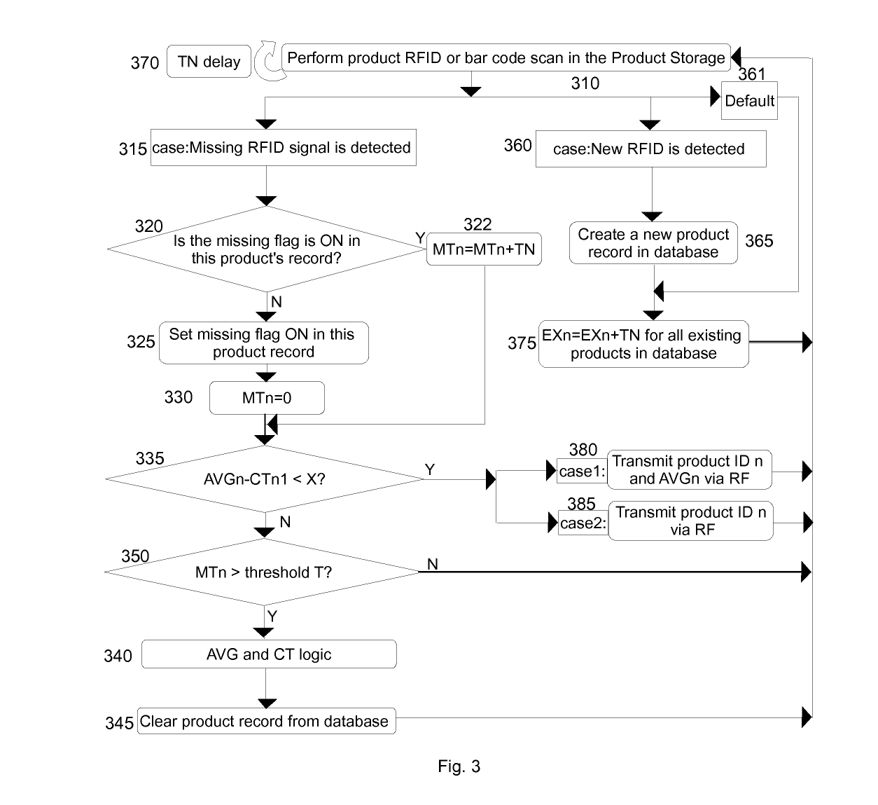

FIG. 1 is a system block diagram illustrating the system elements of a Product Storage facility and interfaces between the elements in the home 100 environment in accordance with some embodiments. A Product Storage (PS) is a new Product Storage facility that contains stored products and controller sections. Examples for Product Storage are, but not limited to: refrigerator, kitchen cabinets and medicine cabinets. The Product Storage in FIG. 1 is divided into two sections. The first section is the Product Storage Controller (PSC) 110 section. This section hosts the electronic components, which control the Product Storage functionality. RFID reader (RR) 120 is capable of reading RFIDs content from passive, semi-passive or active RFID types. The RFID is affixed to a product's package. The (RR) 120 is connected to the Process (P) 125. The processor (P) 125 executes the Product Storage logic code that resides in the Code Memory (CM) 137. The Product Storage functional logic illustrated by FIG. 3 will be discussed later. The (P) 125 utilizes the Data Memory (DM) 135 as a temporary data storage and a database storage. Both (CM) 137 and (DM) 135 are connected to the (P) 125. RF Module (RFM) 130 is an RF circuitry that interfaces to the (P) 125 and provides RF transmission and reception capability. The RF transmission and reception capability supported by (RFM) 130 could be based on different RF standards and proprietary RF air interfaces. RF Standard interfaces examples are, but not limited to: WiFi, Bluetooth, cellular data such as 3G, 4G, different RFID classes and others. Bar-code scanner (BS) 133 is also connected to the P (125). (BS) 133 is used to scan the Bar-code on products.

The second section of the Product Storage is the Product Storage Content (PSCN) 112. This section contains the actual food or other product type packages, which in this example are: Product 1, 2, 3 (141, 142, 143). Some of the product packages illustrated in FIG. 1 have an associated RFID affixed to their package (144, 146). Other products such as Product 3 (143) does not have an RFID but have an associated Bar-code 148. The products' packages with Bar-code could be scanned by the Barcode scanner (BS) 133. The Display Device (DD) 160 is a wired or wireless device that has processing, communication and display capabilities. Examples for such devices are, but limited to: Cellular phones, Smartphones, tablets, PDAs, Computers, Integrated Refrigerator computer with a display, which also can be used to manually enter product information, MP3 players with communication capabilities and so on. The RF protocol supported by these devices are, but not limited to: 2G, 3G, 4G CDMA, TDMA, OFDMA, WiFi, passive, semi-passive, dynamic RFID with a variety of standard classes. The upper protocols (layer 3 and up) over the RF air interfaces could be, but not limited to: IP standard protocols such as IP, TCP, UDP, HTTP and so on.

Here is an example of two WiFi network configurations that are implemented in some embodiments utilizing (RFM) 130 WiFi air interface. In the first configuration the (RFM) 130 utilizes an already existing WiFi network at home. Home WiFi Router (WR) 150 relays the WiFi transmission signal 158 from the (RFM) 130 to WiFi transmission signal 155 that targets the WiFi capable (DD) 160. In another WiFi configuration, the RF transmission signal from (RFM) 130 (signal 159) directly targets the (DD) 160. The (DD) 160 needs to have the capability to at least receive the RF format and standard transmitted by the (RFM) 130 or by the relay router (WR) 150.

The RF air interfaces supported by the (RFM) 130 could be, but not limited to: WiFi and other standard RF formats such as different classes of RFID (active, semi-passive and passive) Blue tooth, 3G, 4G or other. RF air interfaces protocols could be implemented to perform half or full duplex transmission protocols.

The upper protocols (layer 3 and up) over the RF air interfaces could be, but not limited to: IP standard protocols such as IP, TCP, UDP, HTTP and so on.

In some embodiments the (DD) 160 receives the RF transmitted information from the (RFM) 130 or the relayed transmission from (WR) 150. The transmission contains information regarding the products 141, 142 and 143 such as, but not limited to: product ID and consumption-pattern that were calculated by (P) 125. The information is stored in the (DD) 160 Data Memory (DM) 135 for future application use.

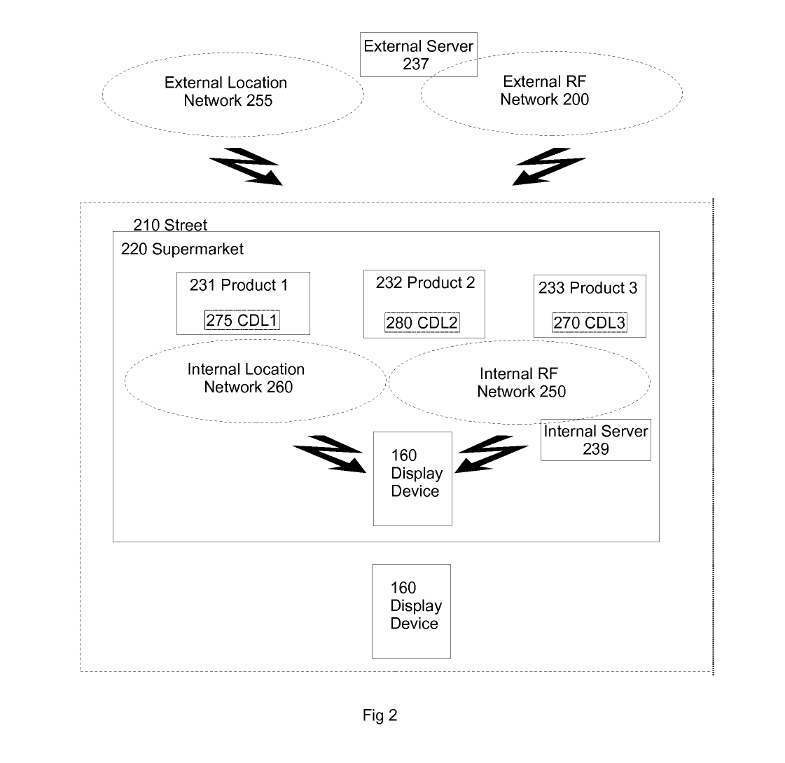

FIG. 2 illustrates the architecture elements and interfaces of the system, in accordance with some embodiments, when the (DD) 160 is not at home environment. In FIG. 2 example, street (210) and supermarket (220) environments are illustrated. 200 is an External RF Network (ERN) that covers both the street 210 and the supermarket 220.

This RF network is typically implemented by a cellular network technology such as 2G, 3G an 4G utilizing TDMA, CDMA and OFDMA RF air interfaces. 250 is an Internal RF Network (IRN) that typically covers the inside of a supermarket. This network could be based on WiFi, Blue tooth, RFID (active, passive or semi-passive) or cellular technology utilizing different spectrum than the public cellular network.

The upper data protocols (data layer 3 and up) of these networks could be, but not limited to: IP standard protocols such as such as IP, TCP, UDP, HTTP and so on.

255 is an External Location Network (ELN) such as GPS based satellites network. This network covers the street 210 and could partially cover the internal supermarket space 220. 260 is an Internal Location Network (ILN) 260 that covers the internal supermarket space 220. (ILN) 260 could be implemented as, but not limited to: centralized or distributed WiFi network or distributed network of blue tooth access points or RFID network elements. The (DD) 160 utilizes the (ELN) 255 to identify the closest supermarket that offers the relevant lot-based and other products promotion types. (ILN) 260 is used to identify the location information of a lot-based or other promoted product inside the supermarket. External or internal location network information that identifies supermarket or promoted products locations could trigger lot-based promotions search and/or lot-based promotion presentation by (DD) 160. In another embodiment product promotion information that is not related to specific product's lot but related to consumer's consumption-pattern could also be searched and presented by the (DD) 160.

In some embodiments the External and Internal Servers (237, 239) could automatically trigger (DD) 160 lot-based and other promotion related to consumer's consumption-pattern applications. This option serves consumers that pre-subscribed to “Green-saving-Network” service example as followers for specific food retailers that offer lot-based or other types of product promotions. The consumer in this example pre-subscribes to “Green-Saving-Network” using (DD) 160 or other wire or wireless computer devices, which are able to communicate with the External or the Internal Servers (237, 239). The (DD) 160 (at least) displays the lot-based and other promotions that are relevant to the consumer's consumption-pattern. (DD) 160 could also present other relevant product information. In some embodiments the (P) 125 could directly and automatically update the External or Internal servers (237, 239) with the consumption-patterns of products via RF Module 130. In another embodiments the (DD) 160 will directly update the External or Internal servers (237, 239) with the consumption-patterns of products.

(DD) 160 provides product IDs and other optional parameters to the Internal Server (IS) 239 or the External Server (ES) 237 via Communication Networks 250 or 200. The promotion information and related product are transmitted from the (IS) 239 or the (ES) 237 via Communication Networks 250 or 200.

The upper data protocols (data layer 3 and up) of these servers could be, but not limited to: IP standard protocols such as such as IP, TCP, UDP, HTTP and so on.

In some embodiment the Cycled Discount Labels (CDL1, CDL2, CDL3) (275, 280, 270) are affixed to Products 1,2,3 (231, 232, 233) on supermarket's shelves. The CDLs that are affixed on the products are relevant to the lot-based promotion embodiments. The association between product's CDL and the promotion presentations are described and claimed in details in U.S. patent application Ser. No. 12/643,311.

FIG. 3 illustrates an example of functionality logic of the Product Storage Controller (PSC) 110, in accordance with some embodiments, which is executed by the Processor (P) 125. The RFIDs on the products are scanned by the RFID reader (RR) 120. The RFIDs (at least) contains the product ID, which is used as presence and absent indications of the product. However, the basic logic, which is describes in FIG. 3 could be performed based on bar-code scanning, which provides at least the product ID information to determine the presence and absent indications of the product. In this case Bar-code Scanner (BS) 133 performs the optical Bar-code scanning. (RR) 120 scans the (141, 142) products' RFID 144, 146 at step 310. In some embodiments the (RR) 120 scans periodically all RFID signals in the Product Storage every TN delay 370 time. Three cases could be considered at this point in the logic flow chart. If 315 or 360 case conditions do not meet than the (P) 125 executes the default 361 case. Step 375 is the only function performed in this case. At step (375) all existing products in the database records (EXn) are incremented by TN time.

360 case is defined by the detection of a new RFID signal from a product that does not exist in the Product Storage Controller (PSC) 110 Data Memory (DM) 135 database. At step 365 a new product record is created by the (P) 125 in (DM) 135 database for the new product. All EX (existing) product records n are incremented at step 375 by TN delay time 370. More information is required in a case that more than one product of the same type are placed in the Product Storage. Serial number or other identification information in the RFID is required in addition to product's ID to distinguish between the different items of the same product type.

The third case is the 315 case where the product is already exists in the (DM) 135 database however, it cannot be found inside the Product Storage by the routine scan. This case is triggered by the absence of RFID signal information or Bar-code information of previously detected products. The assumption in this case is that the product was taken out of the Product Storage. At step 320 (P) 125 checks if this product was already marked as missing. If yes than the MT (Missing Timer) record element for product n is incremented by TN at step 322. If this is the first time this product was detected as missing than the missing flag is set to ON at step 325 and the missing timer is cleared at step 330. In some embodiments two consumption parameters are kept for each product n. The parameters are: The adaptive old average, which is the AVG and the new consumption timer, which is the CT. The reason for the two parameters in some embodiments is that the consumption-pattern transmission update to the Display Device (DD) 160 by the (P) 125 via (RFM) 130 may be performed shortly before the product was consumed (based on previous consumption parameter) and not after the product was fully consumed. This way the consumer can take advantage of lot-based discounted products or other product discounts at the supermarket shortly before the product in the Product Storage is fully consumed.

At step 335 the (P)125 checks if the new product Consumption Timer minus the adaptive average consumption AVG for product n is less than X. X is the anticipated normal variation of product's consumption time. If it does, then the (P)125 transmit via (RFM) 130 to (DD) 160 at least the product ID at step 385. This step is used by some embodiments such as automatic shopping list generation and promotion presentation of almost consumed products. In this embodiment the relevant general promotions for the almost consumed products, is searched and displayed regardless of their lots. The search and the download of the promotions could be performed by the (P) 125 via RF Module 130 or by the (DD) 160. In another embodiment the almost consumption of a product could be directly sensed by an RFID sensor on the product and be reported to (P) 125.

This RFID sensor could be implemented as passive, semi-active and active RFID device. Liquid level could be directly sensed for milk or juice and be reported to the (P) 125 via (RR) 120. Level of gasses, bacteria or chemical components could be also sensed in other product types and reported to the (P) 125 via (RR) 120. At least both product ID and product's consumption-pattern will be transmitted at steps 380 to support lot-based promotions application embodiments that are based on products consumption patterns of products.

If the missing time of a product is greater than time threshold T (at step 350) than the product is declared as consumed. This step avoids false product consumption detection when product is missing for a short time of a partial consumption. At step 340 the average consumption and recent consumption logic are performed by (P) 125 in some embodiments.

The AVG and CT logic at 340 comprising:

1. The adaptive average updated with weighted new Consumption Time (CT) and the averaging of all recent AVG of the same product.

2. Keeping several previous CT in the database.

3. Setting the AVG to the CT average, if the average of several previous CT is larger that AVG by a defined threshold. The reason for this is to accommodate changes in consumption-pattern.

4. Ignoring a CT if CT minus the AVG is larger or smaller than a pre-defined range. The reason for this logic is to allow few times of non-typical large or small variation of a product's consumption-pattern.

At step 345 the product record is cleared from the (DM) 135 database. The reason behind this step is the assumption that the product was fully consumed after it was missing for a long time.

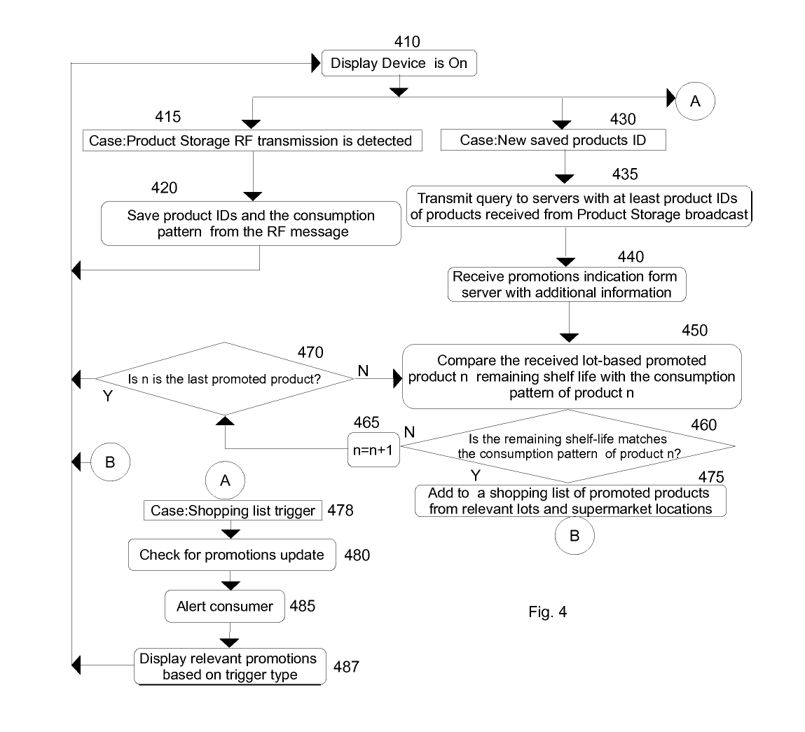

FIG. 4 illustrates the (DD) 160 functionality logic, in accordance with some embodiments. At step 410 the (DD) 160 is ON. There are three cases that could be executed in this embodiment example at this point. At case 415 the (DD) 160 is at home and an RF transmission from the Product Storage is detected. At step 420 the (DD) 160 reads the message and saves the product ID and other related information such as consumption-pattern of this product.

In the second case 430 the (DD) 160 identifies a new saved product ID with or without related consumption-pattern information.

At step 435 the (DD) 160 searches the External and Internal Servers (237, 239) by transmitting query messages containing at least product ID for lot-based or other promotions of the product IDs received from the Product Storage. (237) and (239) servers could be maintained by a supermarkets, food companies or other private or public entities. At step 440 the (DD) 160 receives lot-based or other promotion information with an optional of additional information per promoted product from the Servers (237, 239).

The upper data protocols (data layer 3 and up) supported by Servers (237, 239) are, but not limited to: IP standard protocols such as such as IP, TCP, UDP, HTTP and so on. The information elements per product that were received by (DD) 160 could include, but not limited to: promotion level, remaining shelf life of the promoted product, Cycled Discount Label indication, supermarket location, product location and so on.

Step 450 is relevant to the lot-based promotion embodiment. At this step the (DD) 160 compares each promoted product remaining shelf life to the consumption-pattern of each product that was received from the Product Storage. At step 460 (which is also relevant to the lot-based promotion embodiment only) the (DD) 160 checks if the remaining shelf-life of the promoted product matches the consumption pattern of the product, which was received from the Product Storage. If it does, at step 475 (which is also relevant to the lot-based promotion embodiment only) the (DD) 160 adds this promoted product to the shopping list. The (DD) 160 will continue to check shelf-life correlation for all products received from the Product Storage to the promoted product received from the server (steps 465, 470). These steps are also relevant to the lot-based promotion embodiment only.

The third case is at step 478. In this case the (DD) 160 could be at any location. The consumer may manually, at any time, requests from (DD) 160 promotion options for products in a lot-based or non-lot-based shopping list. This case could also be triggered by different events related to previously created promoted shopping list.

Here are some examples of shopping-list based triggers for case 478:
1. Lot-based or non-lot based-shopping list status (such as length or items' age on the list).
2. Supermarket location.
GPS based supermarket location where some of the lot-based or non-lot-based promoted products from the shopping list are available. In this case the (DD) 160 needs to be GPS enabled and to have the proper application to identify a near by supermarkets.
In this embodiment the shopping list for the lot-based promoted or for non-lot-based promoted products or the combination of the two, could be dynamically partitioned based on the (DD) 160 location. The product promotion in the near-by supermarket will dictate the partitioned content of the (DD) 160 shopping list.
3. Product location inside the supermarket.
The proximity to a lot-based or non-lot-based promoted product from the shopping list is the trigger in this case. The product proximity could be determined by an in-doors location system such as, but not limited to: WiFi, RF means such as RFID devices Bluetooth or optical means such as Bar-code, which could be scanned a (DD) 160 with a Bar-code scanning capability.

At step 480 the (DD) 160 checks for promotion updates. (DD) 160 checks if the product promotion status has been changed. If the product is still promoted the consumer will be alerted at sep 485.

At step 487 the (DD) 160 will display the relevant promotion information, which could be, but not limited to: product description, promotion indication, lot indication and remaining shelf life. The promotions are not limited to price discount, other incentives such as “green points” for future purchases or for charity contribution could be considered as well. The displayed product's information is related to the trigger type. For example if the trigger is a supermarket location than the displayed information is related to product promotions availability offered by the supermarket in the proximity to the consumer's (DD) 160. If the trigger is related to product location inside the supermarket than the display information is related to the product in the proximity of the (DD) 160.

The presentation of products from different lots in the lot-based promotion embodiment, utilizes Cycled Discount Labeling techniques for lot indication are claimed and described in details in U.S. patent application Ser. No. 12/643,311, which was submitted by the same inventor (Averbuch). Other lot indication means could be utilized as well.

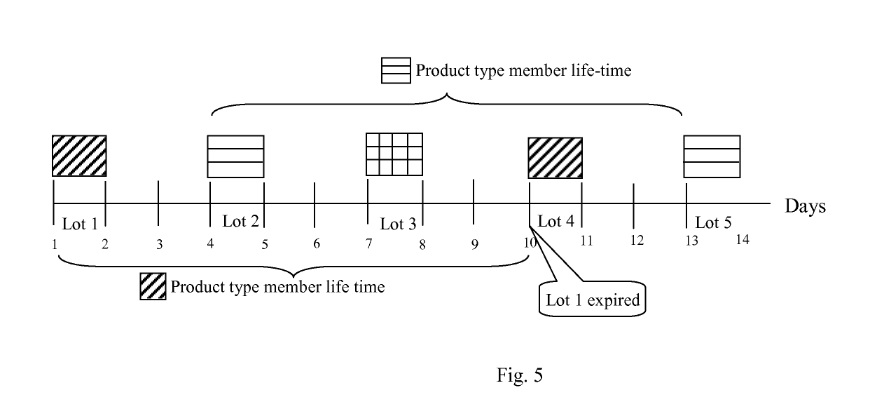

A simple example that illustrates Cycled Discount Labeling technique for lot indication is presented in FIG. 5. Similar Figure and other Cycled Discount Label techniques are described in the original filling of U.S. patent application Ser. No. 12/643,311. In FIG. 5, the product shelf-life is 10 days. The 45° lines pattern is used for Cycled Discount Label for lot 1 and re-used for lot 4.

The identical Cycled Discount Label could be reused as long as the time between the lots that use of the same Cycled Discount Label is equal or grater form the product shelf-life-time. As described in U.S. patent application Ser. No. 12/643,311 the Servers (237, 239) in this invention are also synchronized to the Cycled Discount Label pattern and the time the Cycled Discount Label was affixed. This synchronization could be achieved by reading the Cycled Discount Label information from RFID or Bar-code on the product. The synchronization could also be achieved by loading Discount Cycled Labels sequence and related lot time to Servers (237, 239).

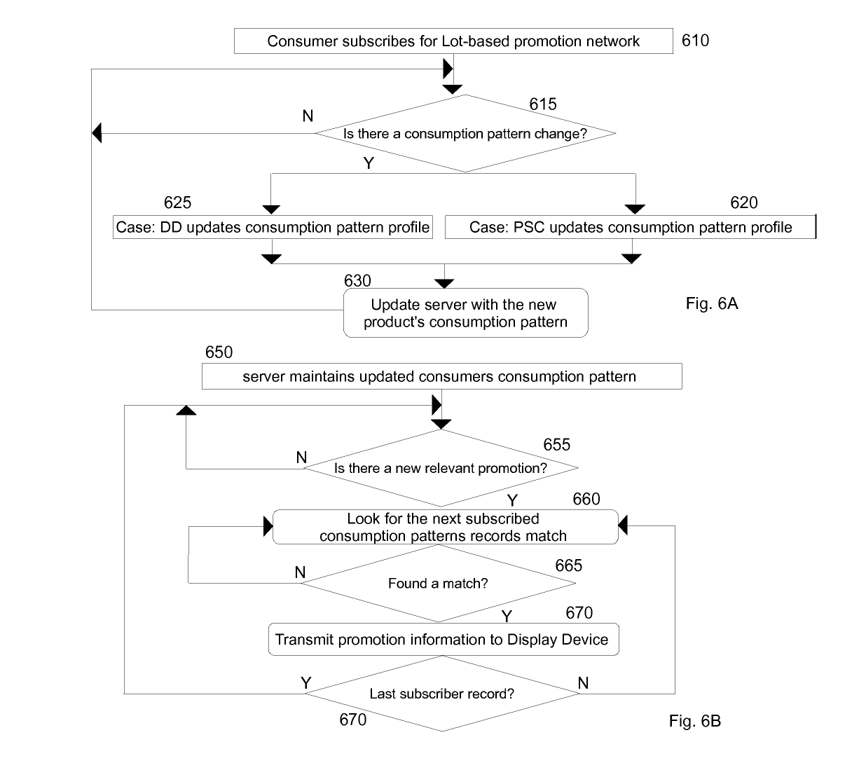

FIGS. 6A and 6B are related to an automatic promotions update embodiment of the External Server (ES) 237 or Internal Server (IS) 239 and automatic promotion transmission embodiment by the External Server (ES) 237 or Internal Server (IS) 239 in accordance with some embodiments. In this embodiment the subscriber is pre-subscribe as a follower to lot-based promotions or other type promotions of products. The offered promotions are relevant to his family's consumption-patterns of specific products.

FIG. 6A illustrates (DD) 160 or (P)125 inside the (PSC) 110 update logic of the subscriber's consumption into (ES) 237 and (IS) 239. At step 610 the assumption is that the subscriber was previously subscribed to this service and therefore, product consumption records on (ES) 237 or (IS) 239 for this consumer are already exists on the servers.

At step 615 the (DD) 160 device or (P)125 inside the (PSC) 110 look for new products' consumption-pattern information. The (DD) 160 updates the new consumption-pattern information at sep 625. The (P)125 inside (PSC) 110 updates the new consumption-pattern information at step 620. The update initiator (DD or PSC) updates the target servers (ES or IS) depends on the application's configuration. At step 630 the (ES) 237 or the (IS) 239 are updated with the new subscriber's product consumption-patterns.

FIG. 6B is a flow diagram example of new promotions identification and promotions transmission logic at the (ES) 237 or the (IS) 239. The location of this functionality depends on the application's configuration.

The assumption at step 650 is that servers (ES) 237 or (IS) 239 are already updated with the current subscriber's consumption-patterns. At step 655 (ES) 237 or (IS) 239 checks for the availability of new lot-based or other type promotions. At step 660 and step 665 the (ES) 237 or (IS) 239 search for subscribers that could benefit from the new promotions. This decision in some embodiments is made by comparing the remaining shelf-life of a specific product lot to the typical subscriber's consumption-pattern. This step is only relevant for the lot-based promotion embodiment. If match is found than the (ES) 237 or (IS) 239 transmit the relevant promotions information to the subscriber's (DD) 160 at step 670.

The (ES) 237 or (IS) 239 perform this loop until the last subscribe record has been processed at step 670 Y.

I claim:

1. A method of product promotion, the method comprising: receiving indications of at least the first product presence and absence; calculating the time it takes to consume at least the first product by at least the first consumer utilizing the first product presence and absence indications; calculating the consumption pattern of at least the first product by at least the first consumer; identifying the promotion information of at least the first lot of the first product that its remaining shelf life matches the consumption pattern of at least the first product by at least the first consumer; displaying on a display device at least one promotion indication and at least one lot indication of at least the first lot of at least the first product.

2. The method of claim 1 wherein the lot indication of at least the first lot of the first product is based on at least one cycled discount labeling technique.

3. The method of claim 1 wherein at least an optical scanning device or RF signal scanning device is used to acquire the information indicating at least the first product presence and absence.

4. The method of claim 1 wherein the display device is stationary or integrated PC based device or mobile device such as cellular phone or smart phone or tablet.

5. The method of claim 1 wherein the display of at least the promotion information of at least the first lot of at least the first product on the display device is triggered by a display device location.

6. A method of promotion of at least the first lot of at least the first product, utilizing at least the first product consumption pattern, the method comprising, at the product storage controller which is a section of product storage facility: receiving at least the first product presence indication and absence indication; if the first product absence time length is more than a time threshold, store the time between the first product first presence indication and the first product absence indication as a consumption time sample of the first product; calculating at least the first product consumption pattern utilizing at least one consumption time sample of at least the first product; initiating a communication session.

7. The method of claim 6 wherein the product storage facility is a refrigerator or medicine cabinet or kitchen cabinet.

8. The method of claim 6 wherein the consumption pattern calculation is, but not limited to an average procedure of the consumption time samples of at least the first product.

9. The method in claim 6 wherein the communication session layers are based but not limited to layer 1 RF protocol and layer 3 and above IP protocols.

10. The method in claim 6 wherein the communication session destination is at least one server or at least one display device

11. The method of claim 6 wherein the communication session initiation is triggered by special sensor indication such as liquid level or concentration level of certain chemicals or certain bacteria.

12. The method in claim 6 wherein the communication session triggers a process to identify at least one promoted lot of at least the first product that its remaining shelf life matches the consumption pattern of at least the first product by at least one consumer.

13. A method of product promotion, the method comprising; at the server: detecting a promotion identification process trigger; identifying the promotion of at least the first lot of at least the first product wherein at least the first lot of the first product remaining shelf life matches at least one consumer consumption pattern;
transmitting at least the first lot indication of at least the first product and the promotion indication of at least the first lot of at least the first product to at least one display device.

14. The method in claim 13 wherein the server is located outside or inside the store or a store chain facility.

15. The method in claim 13 wherein the promotion identification process at the server is triggered by a display device or by a product storage controller message.

16. The method in claim 13 wherein the promotion identification process at the server is triggered by a new promotion of at least one lot of at least one product.

17. The method in claim 13 wherein layer 3 and above of the transmission to and from the server is based on IP protocols.

18. The method in claim 13 wherein the promotion identification process at the server is triggered by a display device location.

19. The method of claim 1 wherein the displayed promotion information of at least the first lot of at the first product on a display device further contains an indication related to the remaining shelf life of the first lot of the first product.
